(19) United States
(12) Patent Application Publication
(10) Pub. No.: US 2018/0062417 A1
(43) Pub. Date: Mar. 1, 2018

(54) CASE FOR PORTABLE TERMINAL HAVING BUILT-IN BATTERY

(71) Applicant: AMOGREENTECH CO., LTD., Gyeonggi-do (KR)

(72) Inventors: Won Gil CHOI, Gyeonggi-do (KR); Seung Yun RHO, Gyeonggi-do (KR)

(73) Assignee: AMOGREENTECH CO., LTD., Gyeonggi-do (KR)

(21) Appl. No.: 15/555,293

(22) PCT Filed: Mar. 3, 2016
(86) PCT No.: PCT/KR2016/002141

§ 371 Date: Sep. 1, 2017

(30) Foreign Application Priority Data
Mar. 3, 2015 (KR) 10-2015-0029912

(51) Int. Cl. H02J 7/02; A45C 11/00; H02J 7/00; H02J 50/12; H01F 38/14; H01F 27/36; H01M 2/02; H01M 10/44; H01M 2/10

(52) U.S. Cl. CPC H02J 7/025; A45C 11/00; H02J 7/0045; H02J 50/12; H01F 38/14; H01M 2220/30; H01M 2/0275; H01M 10/44; H01M 2/1022; A45C 2011/003; A45C 2011/002; H01F 27/365

(57) ABSTRACT

Provided is a case for a portable terminal including a built-in battery. A case for a portable terminal according to an exemplary example of the present invention comprises: a body having a receiving groove configured to accommodate a portable terminal; and a built-in battery mounted in the body, wherein a main battery of the portable terminal is charged by the power of the battery using at least one of a wireless charging method and a wired charging method.

### TECHNICAL FIELD

The present invention relates to a case for a portable terminal, and more particularly, to a portable terminal case including an embedded battery capable of charging a main battery of a portable terminal.

### BACKGROUND ART

Protective cases have been widely used as a part for safely protecting a portable terminal against an external impact or penetration of a foreign substance and for enhancing a decoration effect.

Such protective cases, buffer type cases covering a side surface of a portable terminal and certain type cases which protect a front surface of a portable terminal as well as a rear surface and a side surface of the portable terminal have been widely used.

In order to sufficiently protect the above-described portable terminal from external impacts, various protective materials, such as a metal, a synthetic resin, silicone, or the like, have been used for such portable terminal protective cases.

However, the above conventional protective cases only perform a simple protection function for protecting a portable terminal from an external environment.

On the other hand, as a size of a current portable terminal, as one example, a portable terminal, has been reduced and slimmed, a capacity of a battery embedded in the portable terminal itself is limited. However, a smart phone, which is one kind of portable terminal, has various additional functions, such as an Internet search function, a financial management function, and a video playback function, in addition to a call function, and thus a usage time thereof is gradually increasing.

Due to the increase in usage time, a battery of a portable terminal itself is frequently unable to exceed one day. As a result, the battery needs to be replaced at least once a day or continuously charged via a charging cable.

However, when it is difficult to charge the portable terminal via the charging cable, for example, there is a problem in that the battery of the portable terminal is exhausted and power of the portable terminal is turned off while the user is moving during a long business trip or vacation.

### DISCLOSURE

### Technical Problem

The present invention is directed to providing a portable terminal case capable of performing a unique function as a protective case for protecting a portable terminal, easily charging the portable terminal using a battery embedded in the portable terminal case regardless of location, and increasing a usage time of the portable terminal.

In addition, the present invention is directed to providing a portable terminal case capable of charging a battery of a portable terminal in a wired or wireless manner to charge the battery regardless of a type of portable terminal.

Further, the present invention is directed to providing a portable terminal case capable of preventing a battery from being damaged or occurred performance degradation even though the case is formed of a soft material and the case is deformed in a process of being coupled with or separated from the portable terminal.

Furthermore, the present invention is directed to providing a portable terminal case capable of being thinned by using one wireless power transfer antenna in a wireless power transmission mode or a wireless power reception mode according to a purpose of use.

### Technical Solution

One aspect of the present invention provides a portable terminal case including a main body including a receiving recess configured to accommodate a portable terminal; and a battery embedded in the main body, the portable terminal case may charge a main battery of the portable terminal with power of the battery in at least one of a wireless manner and a wired manner.

The main body may include a rear cover covering a rear cover of the portable terminal and a supporting part extending from an edge of the rear cover to a predetermined height to surround side surfaces of the portable terminal, and the battery may be embedded in the rear cover.

The portable terminal case may include a front cover which is foldably connected to the supporting part to cover a front surface of the portable terminal, and the battery may be embedded in both the rear cover and the front cover.

The main body may include at least one switch provided one side thereof for switching a driving mode of a circuit section.

A connection terminal, which is electrically connected to a circuit section, may be provided on one side of the main body, and the connection terminal may protrude toward an inside of the receiving recess to be inserted into a connection terminal of the portable terminal when the main body and the portable terminal are coupled.

The portable terminal case may include a wireless power transfer antenna functioning as an antenna which sends power for wireless charging using power provided from the battery.

The wireless power transfer antenna may be used as a wireless power transmission antenna so that the wireless power transfer antenna functions as the wireless power transmission antenna for charging the main battery of the portable terminal using the power stored in the battery, and may also be used as a wireless power reception antenna for receiving wireless power supplied from an external charger and charging the battery.

The wireless power transfer antenna may function as the wireless power reception antenna for receiving the wireless power supplied from the external charger when inductance of the wireless power transfer antenna is changed by an interaction between the wireless power transfer antenna and a wireless power transmission antenna provided in the external charger and a power signal transmitted from the external charger is detected.

Some of the power stored in the battery may be used as driving power for driving the wireless power transfer antenna.

Another aspect of the present invention provides a portable terminal case including a main body including a receiving recess configured to accommodate a portable terminal; a battery embedded in the main body; a wireless power transfer antenna functioning as an antenna for transmitting or receiving wireless power; and a circuit section for controlling driving of the wireless power transfer antenna, wherein the wireless power transfer antenna receives wireless power supplied from the outside through one antenna to charge power of the battery or transmits power stored in the battery in a wireless manner to charge a main battery of the portable terminal.

The wireless power transfer antenna may be operated in a transmission mode for transmitting the power stored in the battery in the wireless manner, and may be switched to a reception mode for receiving wireless power sent from a wireless power transmission module through the circuit section at a time at which the wireless power transmission module is detected.

The wireless power transfer antenna may send a power signal periodically for detecting a wireless power reception module.

The circuit section may switch the wireless power transfer antenna to the reception mode when a power signal transmitted from the wireless power transfer module is detected and inductance of the wireless power transfer antenna is changed.

A connection terminal which is electrically connected to the circuit section may be provided on one side of the main body, and the connection terminal may protrude toward an inside of the receiving recess to be inserted into a connection terminal of the portable terminal when the main body and the portable terminal are coupled to allow the power provided from the battery to be supplied to the portable terminal side in a wired manner.

The portable terminal case comprises a shielding sheet provided on one surface of the wireless power transfer antenna for shielding a magnetic field generated in a certain frequency band and focusing the magnetic field in a desired direction.

The shielding sheet may be a ribbon sheet including at least one of an amorphous alloy and a nano-crystalline alloy.

The battery may be a flexible battery having flexibility.

The flexible battery may include an electrode assembly including an positive electrode, a negative electrode and a separator; and a exterior material encapsulating the electrode assembly and an electrolyte, the electrode assembly and the exterior material are provided with patterns for contraction and expansion at a time of bending, and the patterns of the electrode assembly and the exterior material may coincide with each other.

The pattern may be formed totally or partially over an entire length of the flexible battery.

Still another aspect of the present invention includes a main body including a receiving recess configured to accommodate a portable terminal; a flexible battery embedded in the main body; a connection terminal protruding toward an inside of the receiving recess to be inserted into a connection terminal of the portable terminal when the main body and the portable terminal are coupled to allow power provided from the flexible battery to be supplied to the portable terminal side in a wired manner; and a wireless power reception antenna functioning as an antenna receiving wireless power supplied from the outside to charge the flexible battery.

### Advantageous Effects

According to the present invention, a portable terminal case can charge a portable terminal using an embedded flexible battery regardless of location while performing a unique function as a protective case for protecting the portable terminal against an external load, and thus a usage time of the portable terminal can be increased.

In addition, since power of an embedded flexible battery can be supplied to the portable terminal in a wired or wireless manner, a portable terminal case according to the present invention can be employed for all kinds of portable terminals regardless of kind of portable terminal.

In addition, when a battery is implemented as a flexible battery, although a portable terminal case is formed of a soft material, a pattern for contraction and expansion is provided on the flexible battery, Accordingly, even when the case is deformed in a process of being coupled with or separated from the portable terminal, the portable terminal case according to the present invention can flexibly cope with the deformation, thereby breakage and performance degradation of the battery can be prevented.

### DESCRIPTION OF DRAWINGS

FIG. 1 is a view showing a portable terminal case according to one embodiment of the present invention;

FIG. 2 is a partial sectional view of FIG. 1;

FIG. 3 is a view showing a state before coupling a portable terminal and the portable terminal case of FIG. 1;

FIG. 4 is a view showing a state in which the portable terminal is coupled to the portable terminal case in FIG. 1;

FIG. 5 is a schematic view showing a configuration employed in a wireless charging manner in the portable terminal case according to the present invention;

FIG. 6 is a schematic view showing a detailed configuration of a circuit section applied to the portable terminal case according to the present invention;

FIG. 7 is a view showing a detailed configuration of one form of a shielding sheet applied to the portable terminal case according to the present invention;

FIG. 8 is a view showing a portable terminal case according to another embodiment of the present invention;

FIG. 9 is a view showing a portable terminal case according to still another embodiment of the present invention;

FIG. 10 is a view showing one form of a flexible battery applied to the portable terminal case according to the present invention;

FIG. 11 is a schematic view showing a variety of forms of a pattern formed on a exterior material and an electrode assembly in FIG. 10; and

FIG. 12 is an enlarged view showing a detailed configuration of FIG. 10.

### MODES OF THE INVENTION

Hereinafter, exemplary embodiments of the present invention will be described in detail with reference to the accompanying drawings such that one skilled in the art to which the present invention pertains may readily implement the present invention. The present invention may be embodied in many different forms and is not limited to the embodiments described herein. In the drawings, parts not relating to the description have been omitted for clarifying the present invention, and the same reference numerals are assigned to the same or similar components throughout the specification.

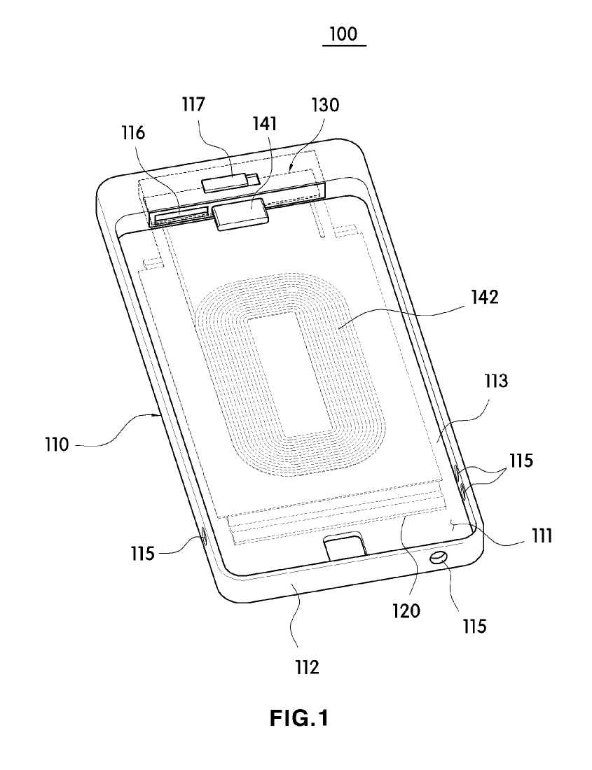

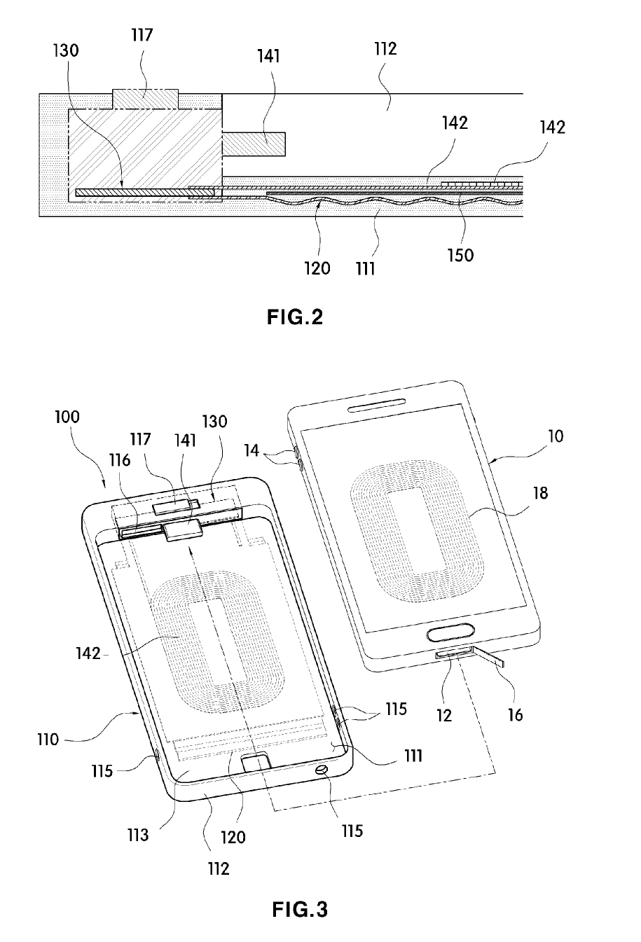

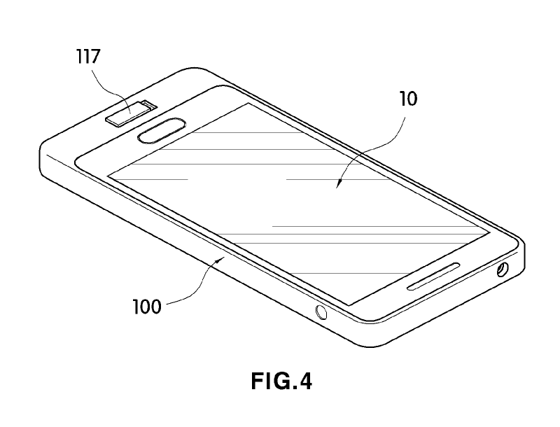

Portable terminal cases 100, 200, and 200′ according to embodiments of the present invention each include a main body 110, a battery 120, and a circuit section 130, as shown in FIGS. 1, 8, and 9.

The main body 110 is coupled to a portable terminal 10 to protect the portable terminal 10 from an external impact and may be provided with a receiving recess 113 having one open side.

This is, the portable terminal 10 may be inserted into the receiving recess 113 to be coupled to the case, or the portable terminal 10 may be taken out of the receiving recess 113 to separate the case and the portable terminal.

To this end, the main body 110 may include a plate-shaped rear cover 111 covering a rear surface of the portable terminal 10 and a support part 112 extending from an edge of the rear cover to a predetermined height to surround side surfaces of the portable terminal 10.

Accordingly, the portable terminal 10 inserted into the receiving recess 113 is prevented from being exposed to the outside except for a front surface thereof by the rear cover 111 and the support part 112.

Here, the support part 112 may be formed as a separate member and then coupled to the rear cover 111, or may be formed integrally with the rear cover 111.

In addition, at least one of the support part 112 and the rear cover 111 may be provided with at least one exposure hole 115 formed in a region corresponding to a manipulation key 14, a camera, and the like to expose the manipulation key, the camera, and the like, which are provided on the portable terminal 10 for a user to manipulate, to the outside.

In addition, one side of the receiving recess 113 may be inwardly incised to a certain depth to form a cap receiving part 116. The cap receiving part 116 provides a space for accommodating a sealing cap 16 when the portable terminal 10 is provided with the sealing cap 16 for protecting a connection terminal 12 (see FIG. 3).

At this time, at least one of the rear cover 111 and the support part 112 may be formed of a rigid material such as a metal or plastic, or may be formed of a soft material such as silicone, leather, a fabric, or the like to reduce an overall weight.

Meanwhile, in the portable terminal cases 100, 200, and 200′ according to the present invention, the battery 120 providing power to the portable terminal 10 for charging a main battery of the portable terminal 10 using a wired or wireless method is embedded in the main body 110.

That is, the battery 120 may be formed of a plate shape and may be embedded in the rear cover 111. Accordingly, when the portable terminal 10 needs to be charged, the main battery of the portable terminal 10 may be charged using the power supplied from the battery 120.

In other words, in a state in which the portable terminal 10 requiring charging is fastened to the receiving recess 113, the main battery of the portable terminal 10 may be charged by using the power of the battery 120 so that it is possible to conveniently charge the portable terminal 10 regardless of location, and since the charging is performed in the state in which the portable terminal 10 is coupled to the receiving recess 113, portability of the portable terminal can be maintained in the charging process.

Further, since the battery 120 is embedded in the plate-shaped rear cover 111 having a predetermined area, it can be provided to have a large area which is substantially the same as the entire area of the rear cover 111, and thereby high capacity can be realized.

In this case, in the portable terminal cases 100, 200, and 200′ according to one embodiment of the present invention, the power provided from the battery 120 may be supplied to the portable terminal 10 side in a wired manner or wireless manner.

As one example, the portable terminal cases 100, 200, and 200′ according to one embodiment of the present invention may include a connection terminal 141 for electrically connecting to the portable terminal 10 and may include a wireless power transfer antenna 142 for transfer wireless power, and the connection terminal 141 and the wireless power transfer antenna 142 may be electrically connected to the circuit section 130.

Accordingly, the portable terminal cases 100, 200, and 200′ according to the present invention can charge the main battery of the portable terminal in a wired manner via the connection terminal 141 or can charge the main battery of the portable terminal in a wireless manner using the wireless power transfer antenna 142. A detailed description thereof will be provided below.

Meanwhile, each of the portable terminal cases 100, 200, and 200′ according to the present invention may include the circuit section 130 electrically connected to the battery 120, and the above circuit section 130 may include a variety of circuits for converting the power supplied from the battery 130 into alternating current (AC) power for wireless charging or into a voltage for wired charging.

Here, the circuit section 130 may be realized as a form of circuit section in which various circuit patterns for a wired charging circuit and/or a wireless charging circuit, at least one chipset or diode, and various passive elements are mounted on at least one surface of a circuit board.

That is, in the circuit section 130, the circuit board is electrically connected to the battery 120 embedded in the main body 110 to convert the power supplied from the battery 120 into the voltage for wired charging through the wired charging circuit or to convert direct current (DC) power supplied from the battery 120 into AC power and apply the AC power to the wireless power transfer antenna 142, which will be described below, to transfer wireless power.

At this time, the circuit section 130 may include a voltage drop section (not shown) for dropping an output voltage provided from the battery 120 to a voltage suitable for wired charging and providing the dropped voltage to the portable terminal 10 side, and various protective circuits may be included.

Meanwhile, when both a wired charging method and a wireless method are applied to the portable terminal cases 100, 200, and 200′ according to the present invention as the method for charging the main battery of the portable terminal using the power of the battery 120, at least one switch 117 may be provided for switching a status of the circuit section 130.

As one example, the switch 117 is provided on one side of the main body 110 to be electrically connected to the circuit section 130, may switch the circuit section 130 to a wired charging mode and a wireless charging mode through a user's manipulation, and may include a non-charging mode. In addition, when the wireless power transfer antenna 142 is operated in both a reception mode and a transmission mode, the switch 117 may switch the wireless power transfer antenna 142 into the reception mode or the transmission mode.

By describing in detail, when power of the main battery of the portable terminal 10 is completely or partially consumed and the main battery of the portable terminal 10 is to be charged in a wired manner, the user manipulates the switch 117 to switch the circuit section 130 to the wired charging mode and thereby the main battery of the portable terminal 10 is charged using the power of the battery 120 supplied through the connection terminal 141.

In addition, when the power of the main battery of the portable terminal 10 is completely or partially consumed and the main battery of the portable terminal 10 is to be charged in a wireless manner, the user manipulates the switch 117 to switch the circuit section 130 to the wireless charging mode and thereby the main battery of the portable terminal 10 is charged using the power of the battery 120 supplied as the wireless power through the wireless power transfer antenna 142.

In addition, when it is desired to simply protect the portable terminal 10 without charging the main battery of the portable terminal 10, the user manipulates the switch 117 to switch the circuit section 130 to the non-charging mode and thereby the case serves as a protective case for simply protecting the portable terminal 10 coupled to the receiving recess 113 from an external environment.

As described above, the portable terminal cases 100, 200, and 200′ according to the present invention allows a user to select a charging mode and the non-charging mode through manipulation of the switch 117 so that the portable terminal cases 100, 200, and 200′ according to the present invention may be employed as an auxiliary battery or a simple protective case.

In addition, when the portable terminal 10 to be charged does not have a wireless power reception antenna 18, charging is performed through the wired charging mode, and when the portable terminal 10 is provided with the wireless power reception antenna 18, the wired charging mode and the wireless charging mode may be selected by the user.

In other words, the portable terminal cases 100, 200, and 200′ according to the present invention may function as an auxiliary battery capable of charging the main battery of the portable terminal 10 through the power supplied from the battery 120 embedded in the main body 110, and may employ both the wired charging method and the wireless charging method through a single device.

Here, although the switch 117 is illustrated as being provided in a slide manner in the drawings, the present invention is not limited thereto, and a button type switch including at least one button or a rotary type switch may be applied as the switch 117. It should be understood that a variety of types of known switches may be applied as the switch 117 as long as a status can be shifted by the user's manipulation.

The connection terminal 141 is provided to electrically connect the portable terminal 10 and the battery 120 to charge the main battery of the portable terminal 10 in a wired charging manner.

The connection terminal 141 may correspond to the connection terminal 12 formed on one side of the portable terminal 10. As one example, the connection terminal 141 may be configured to protrude from one side of the main body 110 toward the receiving recess 113 side (see FIG. 1).

Accordingly, when the portable terminal 10 is inserted into the receiving recess 113, each of the portable terminal case 100, 200, and 200′ and the portable terminal 10 may be coupled to each other in a state in which the connection terminal 141 is inserted into the connection terminal 12 of the portable terminal 10 (see FIG. 3).

At this time, the connection terminal 141 is inserted into the connection terminal 12 of the portable terminal and, at the same time, the battery 120 is electrically connected to the portable terminal such that the main battery of the portable terminal 10 may be charged using the power supplied from the battery, but the battery may be electrically connected to the portable terminal 10 through the connection terminal 141 only when the user manipulates the switch 117 to switch the circuit section 130 to the wired charging mode as described above.

That is, when the battery 120 and the portable terminal 10 are electrically connected to each other through the connection terminal 141, the main battery of the portable terminal 10 is charged using the power supplied from the battery 120.

Meanwhile, the wireless power transfer antenna 142 is provided for transmitting wireless power to the wireless power reception antenna 18 of the portable terminal 10 to charge the main battery of the portable terminal in a wireless manner when the wireless power reception antenna 18 is embedded in the portable terminal 10.

At this time, the wireless power transfer antenna 142 may be embedded in the rear cover 111 together with the battery 120.

However, the present invention is not limited thereto, and the wireless power transfer antenna 142 may be attached on one surface of the main body 110 through an adhesive layer and then protected by a separate protective film.

The wireless power transfer antenna 142 may be formed with a coil having a shape such as a circular, elliptical, spiral, or a polygonal shape such as quadrangular shape, and may be wound in a clockwise or counterclockwise direction, and a metal foil such as a copper foil may be etched on at least one surface of a circuit board or a conductive ink may be printed in a predetermined pattern on at least one surface of a circuit board.

Here, it should be understood that when the wireless power transfer antenna 142 is pattern-formed on the circuit board, the circuit board may be formed integrally with the circuit board constituting the circuit section 130 or formed with separate members.

The wireless power transfer antenna 142 functions as a wireless power transmission antenna for transmitting wireless power to the wireless power reception antenna 18 side provided in the portable terminal 10, and driving thereof is controlled by the circuit section 30.

Here, some of the power stored in the battery 120 may be used as driving power of the circuit section 130 for driving the wireless power transfer antenna 142.

That is, the wireless power transfer antenna 142 may send a magnetic field in a predetermined frequency band using the power provided from the battery 120 in a state in which the circuit section 130 is switched to the wireless charging mode through manipulation of the switch 117.

As one example, when the power is supplied to the circuit section 130 side by the battery 120, the power supplied from the battery 120 is converted into a constant voltage and current through a converter 132, the DC power supplied from the battery 120 may be converted into AC power through the inverter 133, and wireless power may be then transmitted through the wireless power transfer antenna 142.

Here, the circuit section 130 may include a controller 131 controlling overall operations thereof and generating a control signal for controlling characteristics of a frequency, an applied voltage, a current, and the like used for generating the power signal sent from the wireless power transfer antenna 142, and the power signal may include the information including at least one of information on the amount of power of the portable terminal, which is an object to be charged, information on a charging status, information on power suitable for a load requested by the object to be charged, and identification information.

Accordingly, the wireless power reception antenna 18 provided in the portable terminal 10 generates power using the electromagnetic field sent from the wireless power transfer antenna 142 to charge the main battery of the portable terminal 10.

Here, both a known magnetic induction method and a magnetic resonant method for generating an electromagnetic field using a coil and transmitting power via the electromagnetic field may be applied as a principle of power transmission and reception using the wireless power transfer antenna 142. Since the wireless charging technique using the above-described magnetic induction method and magnetic resonant method is a well-known technology, a detailed description thereof will be omitted.

At this time, since the portable terminal 10 and the main body 110 are maintained in a coupled state by the portable terminal being inserted into the receiving recess 113, a separate operation for aligning the wireless power transfer antenna 142 functioning as a wireless power transmission antenna and the wireless power reception antenna provided in the portable terminal is unnecessary.

Furthermore, since the wireless power transfer antenna 142 and the wireless power reception antenna provided in the portable terminal 10 maintain a state of a short distance therebetween by the portable terminal 10 being coupled to the main body 110, the wireless charging can be performed smoothly.

The battery 120 is embedded in the main body 110 and supplies power for charging the main battery of the portable terminal 10.

Although a well-known battery having rigidity may be used as the battery 120, a flexible battery having flexibility may be provided as the above-described battery to reduce an overall weight, realize a thin thickness, and allow the battery to be deformed to the same extent as the main body 110 when the main body 110 is formed of a flexible material.

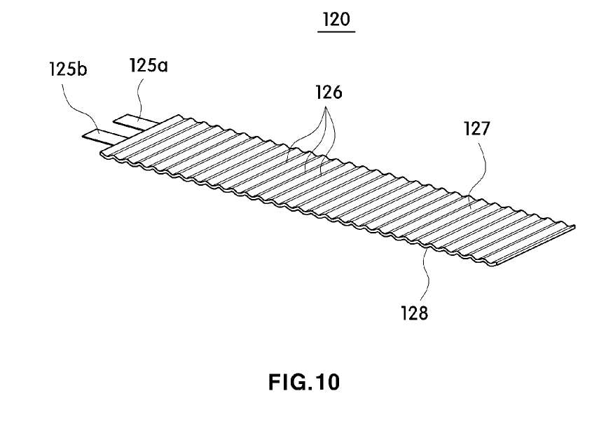

As shown in FIGS. 10 to 12, the above-described flexible battery includes an electrode assembly 121 and exterior materials 127 and 128, and the electrode assembly 121 is encapsulated in the exterior materials 127 and 128 together with an electrolyte.

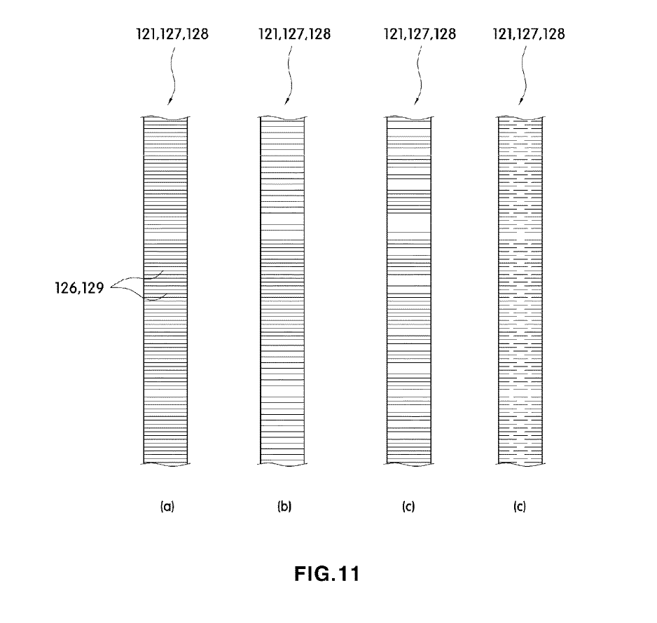

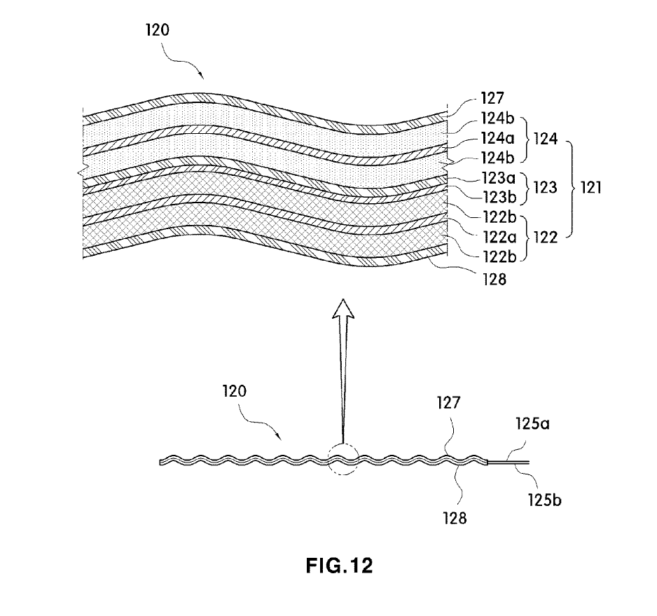

At this time, the electrode assembly 121 may be provided with a pattern 129 for contraction and expansion and the exterior materials 127 and 128 may each be provided with patterns 126 for contraction and expansion. As one example, the patterns 126 and 129 for contraction and expansion may be formed in a longitudinal direction or a width direction of the electrode assembly 121 and the exterior materials 127 and 128. In addition, the first pattern 129 formed on the exterior materials 127 and 128 and the second pattern 126 formed on the electrode assembly 121 may be provided in the same direction with each other (see FIGS. 11 and 12).

Even though the main body 110 is deformed during use, such patterns 126 and 129 cancel out the amount of change caused by a curvature at the time of deformation to prevent or minimize contraction or expansion of a basic material itself.

As one example, when the main body 110 is formed of a soft material and the main body 110 is deformed in a process of coupling or separating the portable terminal 10 to or from the main body 110, it is possible to prevent damage to the battery 120 by such deformation.

In other words, since a deformation amount of the basic material itself constituting the electrode assembly 121 and the exterior materials 127 and 128 is prevented or minimized, even when the main body 110 is deformed, as one example, bent, the amount of deformation of the basic material itself, which may be generated on a bent portion, is minimized so that it is possible to prevent damage to or performance degradation of the electrode assembly 121 and the exterior materials 127 and 128.

At this time, the first pattern 129 and the second pattern 126 are arranged so that the first pattern 129 and the second pattern 126 coincide with each other and have the same directionality. This is to ensure that the first pattern 129 and the second pattern 126 always have the same behavior.

In other words, when the battery 120 applied to the present invention is provided as a flexible battery, since the patterns 126 and 129 for contraction and expansion generated on the electrode assembly 121 and the exterior materials 127 and 128 in the longitudinal direction at a time of bending are formed to coincide with each other, even when bending is generated in the longitudinal direction, the electrode assembly 121 and the exterior materials 127 and 128 may always maintain a uniform gap or may be kept in contact with each other over an entire length thereof so that it is possible to prevent performance degradation of the battery due to the uniform distribution of the electrolyte, which is encapsulated with the electrode assembly 121, over the entire length.

At this time, peaks and valleys of each of the first pattern 129 and the second pattern 126 may be formed in a direction parallel with respect to the width direction of the exterior materials 127 and 128 and the electrode assembly 121, and may be alternately disposed along the longitudinal direction of the exterior materials 127 and 128 and the electrode assembly 121 (see FIG. 11).

In addition to the above, the first pattern 129 and the second pattern 126 may be formed to coincide with each other by forming the peaks constituting the first pattern 129 and the second pattern 126 at the same location and forming the valleys constituting the first pattern 129 and the second pattern 126 at the same location.

In addition, the patterns 126 and 129 may be continuously formed in a direction parallel with respect to the width direction of the electrode assembly 121 and the exterior materials 127 and 128 or may be formed discontinuously, and the patterns 126 and 129 may be formed over to the entire length of the electrode assembly 121 and the exterior materials 127 and 128 or may be partially formed over a part of the above length.

Here, the above peak and valley may be formed to have any one selected from arc-shaped cross-sections including a semicircle shape, polygonal cross-sections including a triangular shape or rectangular shape, and a variety of cross-sectional shapes obtained by combining the arc-shaped cross-sections and the polygonal cross-sections, and the peaks and valleys may be formed to have the same pitch and width or may be formed to have different pitches and widths.

Accordingly, a fatigue applied to the basic material itself can be reduced through the patterns 126 and 129 even when the exterior materials 127 and 128 and the electrode assembly 121 are embedded in the band portion 110 in a bent state.

Meanwhile, the first pattern 129 and the second pattern 126 may be formed to have the same interval or different intervals between neighboring peaks or between neighboring valleys, and may be formed to have a combination of the same intervals and different intervals.

The electrode assembly 121 is encapsulated in the exterior materials 127 and 128 with the electrolyte and includes a positive electrode 122, a negative electrode 124, and a separator 123 (see FIG. 12).

The positive electrode 122 includes a positive current collector 122a and a positive active material 122b, the negative electrode 124 includes a negative current collector 124a and a negative active material 124b, and the positive current collector 122a and the negative current collector 124a may be provided in the form of a plate-shaped sheet having a predetermined area.

That is, in the positive electrode 122 and the negative electrode 124, the active materials 122b and 124b may be pressed, deposited, or coated on one surface or both surfaces of the current collectors 122a and 124a, respectively. At this time, the active materials 122b and 124b may be provided over an entire area of the current collectors 122a and 124a or may be partially provided over a part of the area.

In addition, a negative electrode terminal 125a and a positive electrode terminal 125b may be formed at the positive current collector 122a and the negative current collector 124b, respectively, for electrically connecting the electrode assembly 121 and an external device. The positive electrode terminal 125b and the negative electrode terminal 125a may extend from the positive current collector 122a and the negative current collector 124a, respectively, to protrude from one side of the exterior materials 127 and 128 or may be exposed on the surfaces of the exterior materials 127 and 128.

At this time, the positive active material 122b and the negative active material 124b may contain a polytetrafluoroethylene (PTFE) component. This is to prevent the positive active material 122b and the negative active material 124b from being delaminated from the current collectors 122a and 124a, respectively, or to prevent a cracking when the flexible battery is bent.

Meanwhile, the separator 123 disposed between the positive electrode 122 and the negative electrode 124 may include a nonwoven fabric layer 123a and a nanofiber web layer 123b disposed on one surface or both surfaces of the nonwoven fabric layer 123a.

Here, the nanofiber web layer 123b may be a nanofiber containing at least one selected from a polyacrylonitrile nanofiber and a polyvinylidene fluoride nanofiber.

Preferably, the nanofiber web layer 123b may consist solely of polyacrylonitrile nanofibers to secure a radial shape thereof and uniform pore formation.

Each of the exterior materials 127 and 128 is formed with a plate-shaped member having a predetermined area and is provided for accommodating the electrode assembly 121 and the electrolyte therein to protect the electrode assembly 121 from an external force.

To this end, the exterior materials 127 and 128 include a pair of a first exterior material 127 and a second exterior material 128, and are sealed by an adhesive along edges thereof to prevent the electrolyte and the electrode assembly 121 accommodated therein from being exposed to the outside and leaking to the outside.

After the exterior materials 127 and 128 constituted by the first exterior material 127 and the second exterior material 128 are formed, all of the edges constituting a sealed portion may be sealed with the adhesive, or after the exterior material is formed by folding one member in half in a width direction or a longitudinal direction, the remaining portion facing the one portion may be sealed via the adhesive.

Meanwhile, the battery 120 that supplies power to the main battery side of the portable terminal 10 may be recharged for reuse.

That is, the battery 120 may be charged through any one of a wired manner and a wireless manner, and both the wired manner and the wireless manner may be applied thereto.

As one example, a separate charging port (not shown) for electrically connecting an external charger may be provided at one side of the main body 110 to be electrically connected to the circuit section 130 so that power supplied from the external charger may be supplied to the battery 120 side via a known charging cable to recharge the battery 120.

At this time, the circuit section 130 may include a voltage drop section (not shown) which drops an output voltage provided from the external charger to a voltage suitable for wired charging and then provides the dropped voltage to the battery 120 side.

As another example, the battery 120 may be recharged through a wireless manner.

In other words, the battery may be recharged through a wireless power reception antenna to receive power which is transmitted from the outside in a known magnetic induction manner or magnetic resonance manner.

At this time, the wireless power reception antenna for charging the battery 120 may be provided separately from the wireless power transfer antenna 142, but the wireless power transfer antenna 142 may be employed as the wireless power reception antenna for receiving wireless power provided from the external charger.

That is, the wireless power transfer antenna 142 according to the present invention may function as a wireless power transmission antenna or a wireless power reception antenna depending on the purpose of use in a single antenna.

In other words, the wireless power transfer antenna 142 may be used as a wireless power transmission antenna to be operated in the transmission mode for charging the main battery of the portable terminal using the power stored in the battery 120, and may also be used as a wireless power reception antenna to be operated in the reception mode for charging the battery 120 by receiving the wireless power supplied from the external charger.

That is, when the wireless power transfer antenna 142 is near a portable terminal provided with a wireless power reception module, the wireless power transfer antenna 142 is switched to be a wireless power transmission antenna to be implemented in the wireless power transmission mode, and when the wireless power transfer antenna 142 is near a wireless power transmission module, the wireless power transfer antenna 142 may be switched to be a wireless power reception antenna to be implemented in the wireless power reception mode.

In addition, the wireless power transfer antenna 142 may be switched from the transmission mode, in which the wireless power transfer antenna functions as a wireless power transmission antenna for charging the main battery of the portable terminal, to the reception mode, in which the wireless power transfer antenna functions as a wireless power reception antenna for self-charging the battery 120.

As one example, the wireless power transfer antenna 142 may be operated in the transmission mode, in which wireless power is transmitted to charge the main battery of the portable terminal when near a portable terminal including a wireless power reception antenna, and the wireless power transfer antenna 142 may be switched from the transmission mode to the reception mode for self-charging the battery 120 when near a charger provided with a wireless power transmission module including a wireless power transmission antenna.

At this time, the wireless power transfer antenna 142 may be switched from the reception mode to the transmission mode and vice versa by a user's manipulation of the switch 117 provided at one side of the main body 110, but the switching from the reception mode to the transmission mode and vice versa may be performed through the circuit section 130.

As one example, the circuit section 130 may switch the wireless power transfer antenna 142 to be a wireless power transmission antenna when near a portable terminal, and may switch the wireless power transfer antenna 142 to be a wireless power reception antenna when near an external charger.

In addition, when the wireless power transfer antenna 142 is near an external charger in a state in which the wireless power transfer antenna 142 is operated in the transmission mode for charging the main battery of the portable terminal, the circuit section 130 may be switched from the transmission mode to the reception mode. Here, when the wireless power transfer antenna 142 is operated in the transmission mode, the portable terminal 10 may be in a state of being inserted into the receiving recess 113, and when the wireless power transfer antenna 142 is operated in the reception mode, the portable terminal 10 may be in a state of being separated from the receiving recess 113.

By describing in detail, when power is supplied to the circuit section 130, the wireless power transfer antenna 142 may be operated in the transmission mode for performing a function of a wireless power transmission antenna, and a power signal for detecting proximity of the wireless power reception module through a control of the circuit section 130 may be sent to the outside through the wireless power transfer antenna 142 at a predetermined period.

At this time, when a change of inductance of the wireless power transfer antenna 142 is generated and another power signal sent from the outside is not detected in the process of sending the power signal by the wireless power transfer antenna 142, an amount of power according to a load required by the portable terminal is adjusted such that the power stored in the battery 120 is consumed and the battery of the portable terminal is charged.

In a state in which the wireless power transfer antenna 142 is operated in the transmission mode to send the power signal through the wireless power transfer antenna 142 at a predetermined period, as described above, in addition, when another power signal sent from the outside is detected by the circuit section 130 along with the change of the inductance of the wireless power transfer antenna 142, the circuit section 130 recognizes that an external charger equipped with a wireless power transmission module is near and switches the wireless power transfer antenna 142 to the reception mode.

Accordingly, the power transfer antenna 142 receives the wireless power transmitted from the wireless power transmission module of the external charger and the battery 120 is self-charged.

To this end, the circuit section 130 may include a variety of circuits for operating the wireless power transmission antenna 130 in the reception mode and the transmission mode.

As one example, the circuit section 130 may include the controller 131 controlling the overall operation of the circuit section 130 and generating the control signal for controlling the characteristics of the frequency, the applied voltage, the current, and the like used for generating the power signal sent from the wireless power transfer antenna 142.

Here, the controller 131 may perform a process of identifying the wireless power reception module and the wireless power transmission module, or may determine whether to initiate wireless power transmission, or may generate the control signal for switching the wireless power transfer antenna 142 from the transmission mode to the reception mode according to a result of detecting the presence of the wireless power reception module and the wireless power transmission module.

In addition, the circuit section 130 may include the converter 131 converting the power supplied from the battery 120 into a predetermined voltage and current or converting the power received through the wireless power transfer antenna 142 into a predetermined voltage and current suitable for the battery 120, and provides the converted voltage and current to the battery 120 side.

In addition, the circuit section 130 may include the inverter 133 for converting the DC power supplied from the battery 120 into AC power, may include a rectifier 135 for converting external power received through the wireless power transfer antenna 142 from AC power to DC power, and may include a voltage drop part 134 for dropping the DC power converted in the rectifier 135 to a voltage suitable for the battery 120.

Here, a well-known micro control unit (MCU) may be used as the controller 131, a pulse width modulator (PWM) control scheme may be applied to the controller 131, and any one of a low-dropout linear regulator (LDO) method or a Buck method may be applied to the voltage drop part 134. In addition, the circuit section 130 may include a protection circuit including a pulse code modulation (PCM) or the like in order to prevent overcharging or to protect various circuits.

In addition, the circuit section 130 may further include a switching circuit switching the wireless power transfer antenna 142 to perform a function of a wireless power transmission antenna when a wireless power reception module is near or switching the wireless power transfer antenna 142 to perform a function of a wireless power reception antenna when the wireless power transmission module is near.

Accordingly, each of the portable terminal cases 100, 200, and 200′ according to the present invention may be operated in the transmission mode for charging a main battery of a portable terminal using the power stored in the battery 120 through the control of the circuit section 130, or may be operated in the reception mode in which the battery 120 is charged by receiving wireless power supplied from an external charger.

As one example, in the case in which the main battery of the portable terminal is to be charged using the portable terminal cases 100, 200, and 200′ according to the present invention, when power is supplied from the battery 120 to the circuit section 130 side, the wireless power transfer antenna 142 is operated in the transmission mode by sending the power signal generated by the controller 131 to the outside at a predetermined period.

Here, the supply of power to the circuit section 130 side may be allowed or blocked through a manipulation of the switch 117. Further, the power supplied from the battery 120 may be converted into a predetermined voltage and current through the converter 132 and then supplied to the controller 131 side, and the power is converted from DC power to AC power by the inverter 133 and then supplied to the wireless power transfer antenna 142 side so that a power signal having predetermined cycle is sent to the outside.

Thereafter, when a change of inductance of the wireless power transfer antenna 142 is generated by an interaction between a wireless power transfer antenna and a reception antenna of a wireless power reception module included in a portable terminal and no other power signal is detected while power signal is sent by the wireless power transfer antenna 142, the circuit section 130 recognizes that a portable terminal having a battery requiring charging is near and adjusts the amount of power according to a load required by the wireless power reception module of the portable terminal so that the power stored in the battery 120 is consumed and the battery of the portable terminal can be charged.

Meanwhile, when the battery 120 is required to be self-charged, charging the battery 120 may be carried out in a wireless manner by a charger including a wireless power transmission module being near the portable terminal case 100, 200, or 200′ according to the present invention.

That is, when the external charger is near the portable terminal case 100, 200, or 200′ in a state in which the portable terminal case 100, 200, or 200′ according to the present invention is operated in the transmission mode to send the power signal through the wireless power transfer antenna 142 at a predetermined period, a change in the inductance of the wireless power transfer antenna 142 is generated by an interaction between a transmission antenna of the wireless power transmission module included in the external charger and the wireless power transfer antenna. At the same time, when another power signal sent from the charger is detected by the controller 131, the controller 131 recognizes that the charger is near and blocks the supply of power to the inverter 133 side. Accordingly, the wireless power transfer antenna 142 is switched to the reception mode for self-charging the battery 120 with power to operate as a wireless power reception antenna.

Here, the controller 131 may provide the charger side with information including at least one of information on the amount of power regarding a status of the battery 120, information on a charging status, information on power suitable for a load requested by an object to be charged, and identification information.

Accordingly, after wireless power which is provided from the charger and suitable for the battery 120 is received through the wireless power transfer antenna 142, the wireless power is supplied to the battery 120 sides to charge a power source of the battery 120.

Here, the power received through the wireless power transfer antenna 142 is converted from AC power to DC power through the rectifier 135, changed to a magnitude of the voltage suitable for the battery 120 through the voltage drop part 134, and then supplied as a predetermined voltage and current by the converter 132 so that charging the battery 120 can be carried out.

As described above, the portable terminal case 100, 200, or 200′ according to the present invention may wirelessly transmit or receive power to charge the main battery of the portable terminal or to charge the power source of the battery 120 itself, and, as a result, charging or discharging the battery can be performed without a conventional operation of connecting a cable so that it is possible to improve ease of use.

In addition, since a port, which is an essential configuration for connecting cables in a conventional wired charging or discharging method, is removed, it is possible to prevent a failure caused by penetration of foreign substances and moisture into the portable terminal through the port so that it is possible to extend a service lifetime of the battery 120.

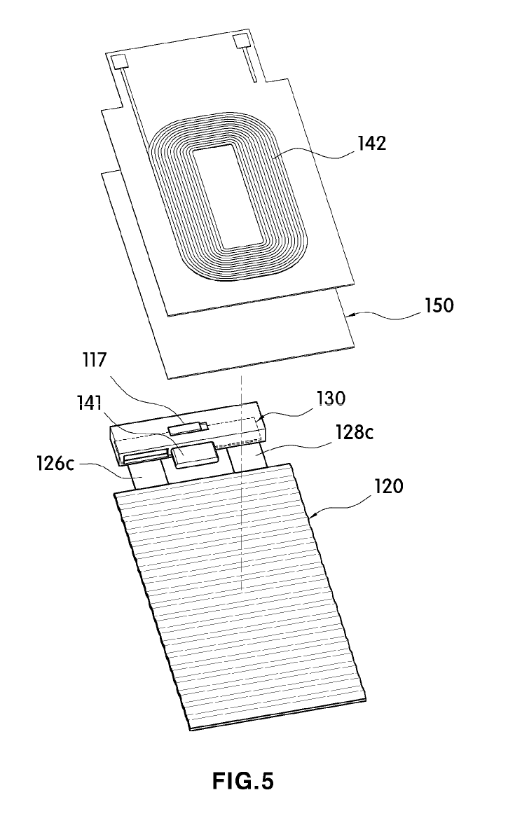

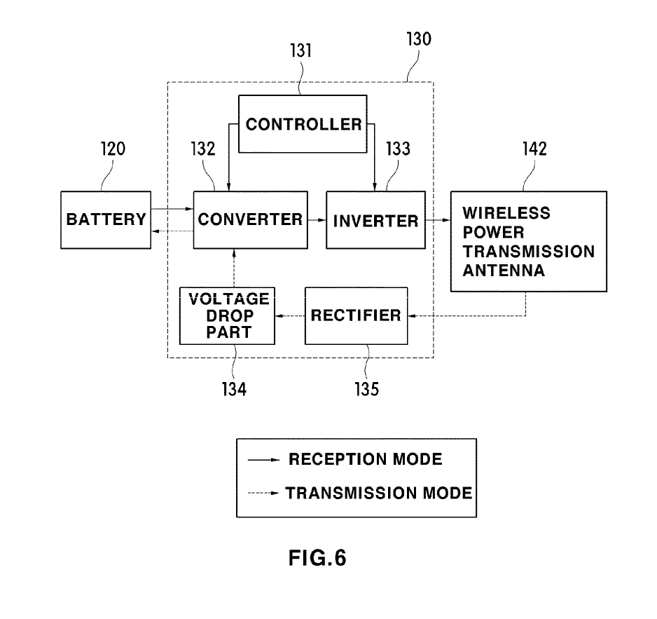

Meanwhile, a shielding sheet 150 for increasing transmission efficiency of the wireless power transfer antenna 142 may be disposed on one surface of the wireless power transfer antenna 142. This shielding sheet 150 is formed with a plate-shaped member having a predetermined area, as shown in FIG. 5, and may be configured to be embedded in the rear cover 111 or to be attached to one surface of the rear cover 111 like the wireless power transfer antenna 142.

The shielding sheet 150 is formed of a material having magnetism to shield a magnetic field generated in the wireless power transfer antenna 142 and focus the magnetic field in a desired direction, and this shielding sheet may be formed of a variety of known materials.

As one example, a ribbon sheet including at least one kind of an amorphous alloy and a nano-crystalline alloy, a ferrite sheet, a polymer sheet, or the like may be employed as the shielding sheet.

Here, the ferrite sheet may include Mn—Zn ferrite or Ni—Zn ferrite, and an Fe-based or Co-based magnetic alloy may be used as the amorphous alloy or the nano-crystalline alloy.

In addition, the shielding sheet 150 may be flaked to be divided into a plurality of fine pieces so generation of eddy currents is suppressed, and may have a multilayer structure to increase permeability.

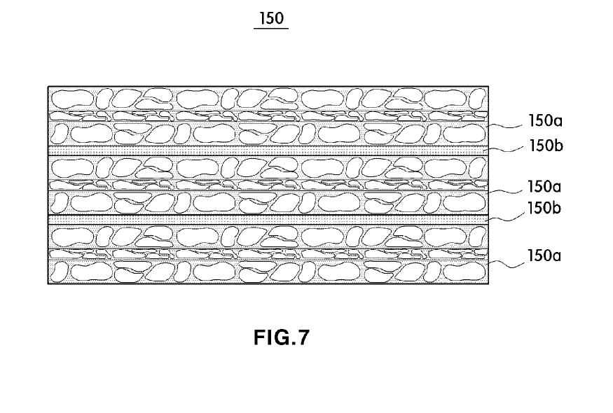

As one example shown in FIG. 7, the shielding sheet 150 includes a plurality of ribbon sheets including at least one of an amorphous alloy and a nano-crystalline alloy and is formed by stacking each of the ribbon sheets into a multilayer via adhesive layers 150b, and the ribbon sheets may be divided into a plurality of fine pieces. In addition, the plurality of fine pieces may be totally insulated or partially insulated from adjacent fine pieces, and each of fine pieces may be irregularly and randomly formed.

Since the shielding sheet 150 has a known configuration, a detailed description thereon will be omitted, and it should be understood that all known shielding sheets may be utilized and employed as the shielding sheet.

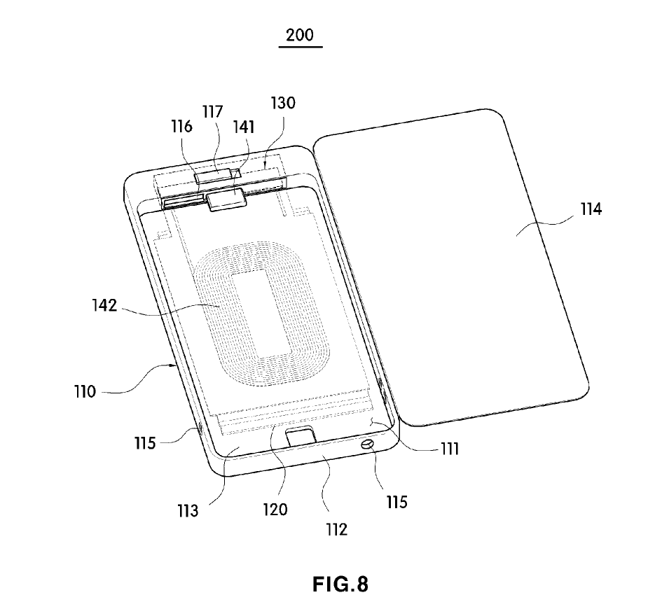

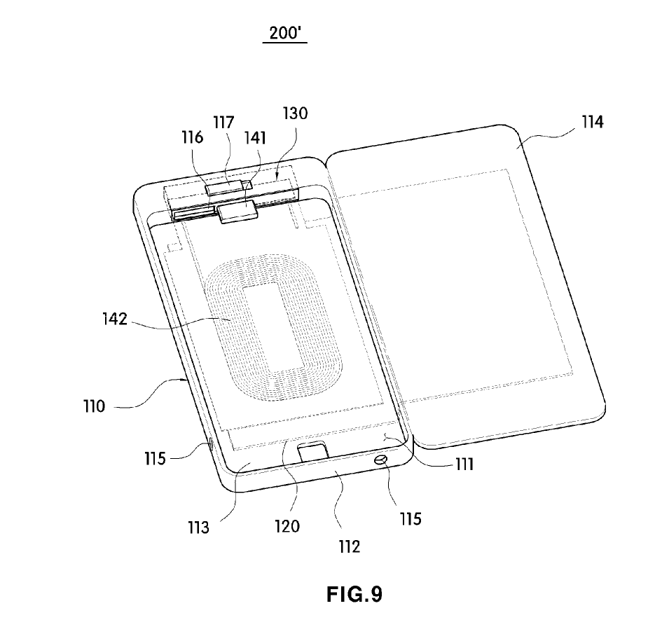

Meanwhile, as shown in FIGS. 8 and 9, the portable terminal case 200 or 200′ according to one embodiment of the present invention may be provided with a plate-shaped front cover 114 which is foldably connected to the support part 112 to cover a front surface of the portable terminal 10 inserted into the receiving recess 113.

At this time, when the portable terminal case according to the present invention includes the front cover 114, the front cover 114 may be formed of a rigid material such as a metal, plastic, or the like to perform a role of only protecting the front surface of the portable terminal 10, and the battery 120 may also be embedded in the front cover 114.

Accordingly, the battery 120 may be embedded in both the front cover 114 and the rear cover 111 to have a large area corresponding to the front cover 114 and the rear cover 111 so that an overall capacity of the battery 120 can be further increased.

Here, when the battery 120 is embedded in the front cover 114, the battery embedded in the front cover 114 and the battery embedded in the rear cover 111 consist of two members and are electrically connected to each other, but the two batteries may be formed as a single body.

In addition, although not shown, it should be understood that, when the battery 120 is formed as a single body and is disposed in both the front cover 114 and the rear cover 111, a pattern for contraction and expansion may be formed in a direction parallel to the longitudinal direction of the support part 112 on a portion of the entire area of the battery 120, which is disposed on the support part 112 side.

Although the portable terminal cases 100, 200, and 200′ according to one embodiment of the present invention are illustrated as being provided with both the connection terminal 141 for the wired charging manner and the wireless power transfer antenna 142 for the wireless charging manner in the drawings, the present invention is not limited thereto, and it should be understood that only the connection terminal 141 may be provided to charge the portable terminal only in a wired charging manner, and only the wireless power transfer antenna 142 may be provided to charge the portable terminal only in a wireless charging manner.

In addition, when the wireless power transfer antenna 142 applied to the present invention functions as both a wireless power reception antenna and a wireless power transmission antenna, the connection terminal for charging the main battery of the portable terminal in the wired manner may be included or omitted.

In addition to the above, it should be understood that when both the wireless power transfer antenna 142 and the connection terminal 141 are included, the connection terminal 141 serves a role of charging the main battery of the portable terminal and the wireless power transfer antenna 142 may function as a wireless power reception antenna to be utilized for charging the battery 120 embedded in the main body 110 in a wireless manner.

Also, it should be understood that the portable terminal cases 100, 200, and 200′ according to the present invention may be applied to a case for portable electronic devices such as a portable media player (PMP), a digital multimedia broadcasting (DMB) system, a tablet personal computer, and the like.

While one embodiment of the present invention has been described in the above description, the spirit of the present invention is not limited to the embodiment disclosed in the specification, and those skilled in the art and understanding the spirit of the present invention may easily suggest other embodiments via adding, modifying, deleting, and a supplementing structural elements within the scope of the spirit of the present invention, and such embodiments are within a scope of the spirit of the present invention.

1. A portable terminal case comprising;
a main body including a receiving recess configured to accommodate a portable terminal; and
a battery embedded in the main body,
wherein a main battery of the portable terminal is charged with power of the battery in at least one of a wireless manner and a wired manner.

2. The portable terminal case of claim 1, wherein:
the main body comprises a rear cover configured to cover a rear cover of the portable terminal and a supporting part configured to extend from an edge of the rear cover to a predetermined height to surround side surfaces of the portable terminal; and
the battery is embedded in the rear cover.

3. The portable terminal case of claim 2, wherein:
the portable terminal case comprises a front cover which is foldably connected to the supporting part to cover a front surface of the portable terminal; and
the battery is embedded in both the rear cover and the front cover.

4. The portable terminal case of claim 1, wherein the main body comprises at least one switch provided on one side thereof for switching a driving mode of a circuit section.

5. The portable terminal case of claim 1, wherein:
a connection terminal, which is electrically connected to a circuit section, is provided on one side of the main body; and
the connection terminal protrudes toward an inside of the receiving recess to be inserted into a connection terminal of the portable terminal when the main body and the portable terminal are coupled.

6. The portable terminal case of claim 1, wherein the portable terminal case comprises a wireless power transfer antenna configured to serve as an antenna which sends power for wireless charging using power provided from the battery.

7. The portable terminal case of claim 6, wherein the wireless power transfer antenna is used as a wireless power transmission antenna so that the wireless power transfer antenna functions as the wireless power transmission antenna for charging the main battery of the portable terminal using the power stored in the battery, and also is used as a wireless power reception antenna for receiving wireless power supplied from an external charger and charging the battery.

8. The portable terminal case of claim 7, wherein the wireless power transfer antenna functions as the wireless power reception antenna for receiving the wireless power supplied from the external charger when inductance of the wireless power transfer antenna is changed by an interaction between the wireless power transfer antenna and a wireless power transmission antenna provided in the external charger and a power signal transmitted from the external charger is detected.

9. The portable terminal case of claim 6, wherein some of the power stored in the battery is used as driving power for driving the wireless power transfer antenna.

10. A portable terminal case comprising;
a main body including a receiving recess configured to accommodate a portable terminal;
a battery embedded in the main body;
a wireless power transfer antenna configured to serve as an antenna for transmitting or receiving wireless power; and
a circuit section for controlling driving of the wireless power transfer antenna,
wherein the wireless power transfer antenna receives wireless power supplied from the outside through one antenna to charge power of the battery or transmits power stored in the battery in a wireless manner to charge a main battery of the portable terminal.

11. The portable terminal case of claim 10, wherein the wireless power transfer antenna is operated in a transmission mode for transmitting the power stored in the battery in the wireless manner, and is switched to a reception mode for receiving wireless power transmitted from a wireless power transmission module through the circuit section at a time at which the wireless power transmission module is detected.

12. The portable terminal case of claim 11, wherein the wireless power transfer antenna sends a power signal periodically for detecting a wireless power reception module.

13. The portable terminal case of claim 11, wherein the circuit section switches the wireless power transfer antenna to the reception mode when a power signal transmitted from the wireless power transmission module is detected and inductance of the wireless power transfer antenna is changed.

14. The portable terminal case of claim 10, wherein:
a connection terminal which is electrically connected to the circuit section is provided on one side of the main body; and
the connection terminal protrudes toward an inside of the receiving recess to be inserted into a connection terminal of the portable terminal when the main body and the portable terminal are coupled to allow the power provided from the battery to be supplied to the portable terminal side in a wired manner.

15. A portable terminal case comprising;
a main body including a receiving recess configured to accommodate a portable terminal;
a battery embedded in the main body;
a connection terminal configured to protrude toward an inside of the receiving recess to be inserted into a connection terminal of the portable terminal when the main body and the portable terminal are coupled to allow power provided from the battery to be supplied to the portable terminal side in a wired manner; and
a wireless power reception antenna configured to serve as an antenna receiving wireless power supplied from the outside to charge the battery.

16. The portable terminal case of claim 6, wherein:
the portable terminal case comprises a shielding sheet provided on one surface of the wireless power transfer antenna for shielding a magnetic field generated in a certain frequency band and focusing the magnetic field in a desired direction.

17. The portable terminal case of claim 16, wherein the shielding sheet is a ribbon sheet including at least one of an amorphous alloy and a nano-crystalline alloy.

18. The portable terminal case of claim 1, wherein:
the battery is a flexible battery having flexibility; and
the flexible battery comprises:
an electrode assembly comprising an positive electrode, a negative electrode, and a separator; and
a exterior material configured to encapsulate the electrode assembly and an electrolyte,
wherein the electrode assembly and the exterior material are provided with patterns for contraction and expansion at a time of bending,
wherein the patterns of the electrode assembly and the exterior material coincide with each other.

19. The portable terminal case of claim 18, wherein the pattern is formed totally or partially over an entire length of the battery.
